(19) United States
(12) Patent Application Publication
(10) Pub. No.: US 2016/0363234 A1
(43) Pub. Date: Dec. 15, 2016

(54) A LEVER FOR A LEVER OPERATED VALVE

(71) Applicant: LINDE AKTIENGESELLSCHAFT, Munich (DE)

(72) Inventors: Stefan Freitag, Hamburg (DE); Tullney Heiko, Hamburg (DE)

(21) Appl. No.: 15/121,416

(22) PCT Filed: Mar. 7, 2014
(86) PCT No.: PCT/EP2014/054490

§ 371 Date: Aug. 25, 2016

(51) Int. Cl. F16K 31/60; F16K 27/12; F17C 13/04; F16K 35/02

(52) U.S. Cl. CPC F16K 31/602; F16K 35/025; F16K 27/12; F17C 13/04; F17C 2205/0308; F17C 2205/0329; F17C 2205/0382; F17C 2205/0394; F17C 2250/043

(57) ABSTRACT

A lever for a lever operated valve which has a base and at least two walls which project away from the base such that the at least two walls project outwardly away from the valve in use when the lever is in the closed position. The walls provide protection for an item located in or on the base of the lever.

The present invention relates to a lever for a lever operated valve. The present invention also relates to a lever operated valve having such a lever.

Cylinder valve assemblies for gas cylinders and the like are well known. Traditionally, cylinder valves are provided with a hand wheel which is operable by rotation to open and close the valve. More recently, cylinder valves which use levers to operate the main valve mechanism have become known. Such a cylinder valve assembly is disclosed in U.S. Pat. No. 5,975,121.

When in the closed position, valve levers lie in close proximity to valve components such as pressure gauges, high pressure outlet, and burst disc etc. The lever must be carefully designed to allow easy operation of the lever while providing adequate protection against accidental opening of the valve and damage to the valve or lever due to impacts.

The present invention provides a lever for a lever operated valve, the lever comprising a base and at least two walls, wherein the at least two walls project away from the base such that, in use, when the lever is attached to a valve in the closed position, the at least two walls project outwardly away from the valve.

The present invention is advantageous as it provides a lever shape which affords protection to an item located in or on the base of the lever.

Preferably the at least two walls are located substantially opposite one another so that they may protect an item located between them.

The at least two walls preferably form part of a continuous peripheral wall which is aesthetically pleasing and affords greater protection by reducing the number of gaps in the walls through which damage may be done.

In a preferred example, the peripheral wall surrounds a major portion of the edge of the base to maximise the protection offered by the wall.

Preferably, the depth of at least one of the at least two walls varies along the length of the wall. This provides for a more aesthetically pleasing appearance and allows the walls to have maximum depth where most needed.

At least one of the at least two walls preferably comprises a lip located substantially at its free edge to provide a convenient grip location for a user.

In a preferred example the base comprises an opening to allow a user to see parts of the valve, for example a gauge, located behind the lever.

A protective member may preferably be located within or over the opening to provide additional protection to the parts of the valve behind the lever.

Preferably, at least one of the at least two walls comprises a button for the operation of an actuation device of a lever fastening device. This allows for the convenient location of an interlock device which prevents unintended opening of the lever.

In another aspect, the present invention provides a lever operated valve assembly comprising a valve body and a lever according to the present invention as described above.

In a further aspect, the present invention provides a kit of parts for forming a lever operated valve assembly, the kit comprising a valve body and a lever according to the present invention as described above.

Examples of the invention will now be described with reference to the following drawings in which:

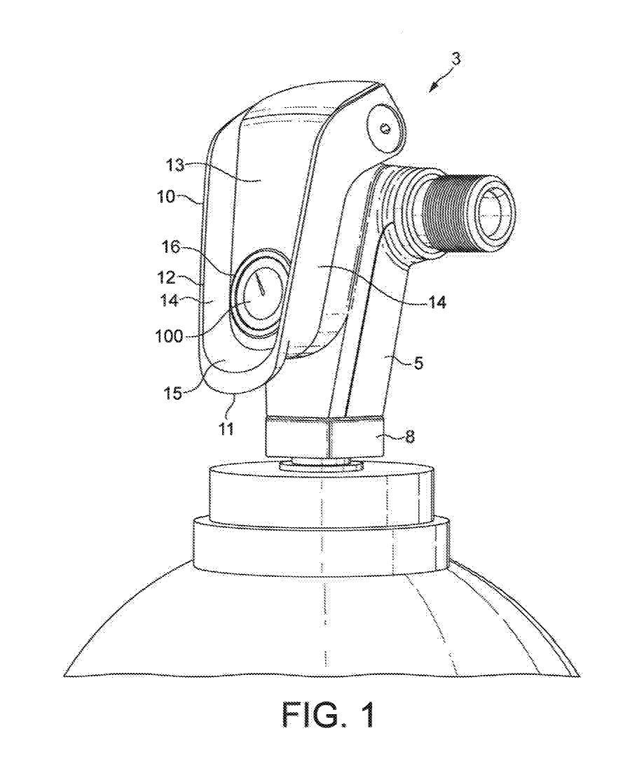

FIG. 1 shows an isometric view of a lever and lever valve assembly according to the present invention;

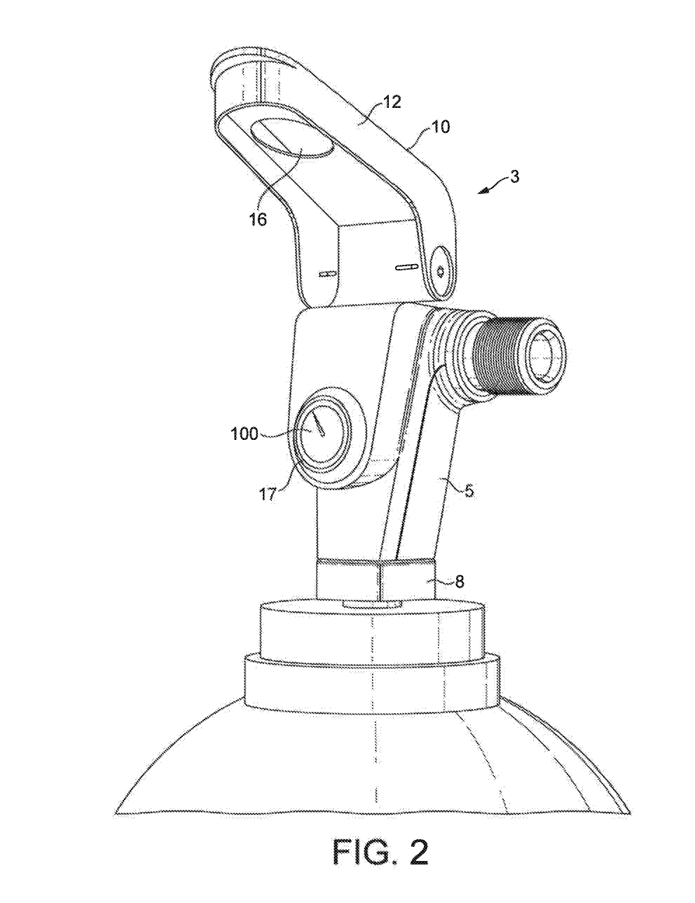

FIG. 2 shows the valve assembly of FIG. 1 in the open position;

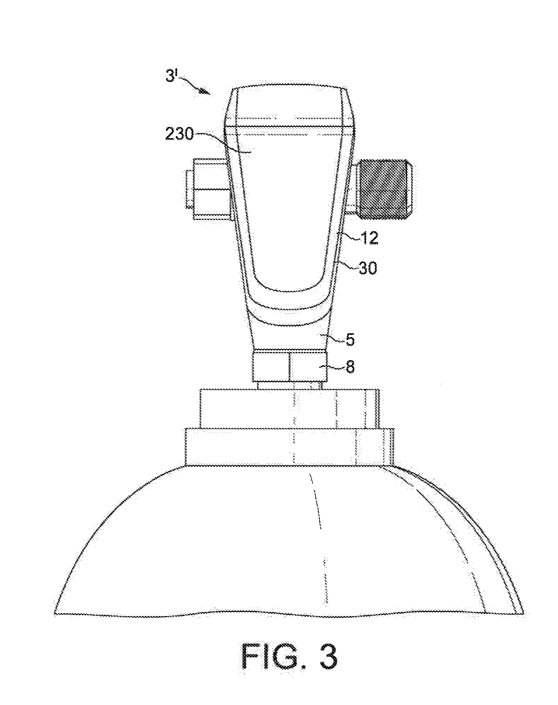

FIG. 3 shows a front view of an alternative embodiment of a lever and lever valve assembly according to the present invention;

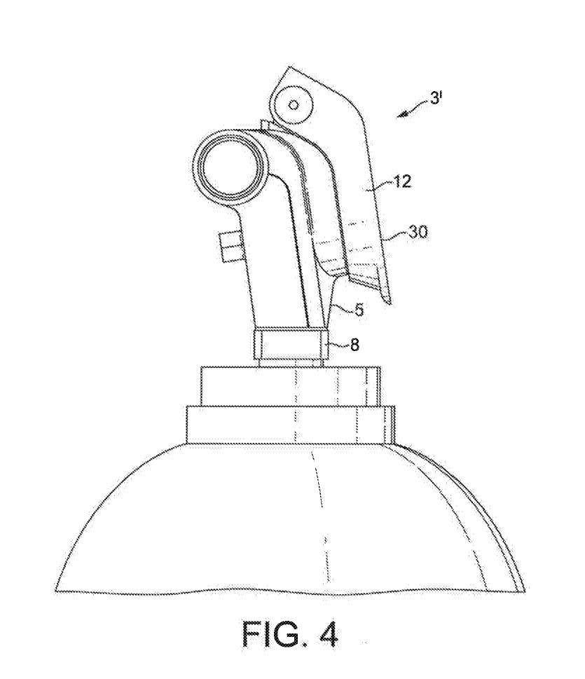

FIG. 4 shows a side view of the lever valve assembly of FIG. 3;

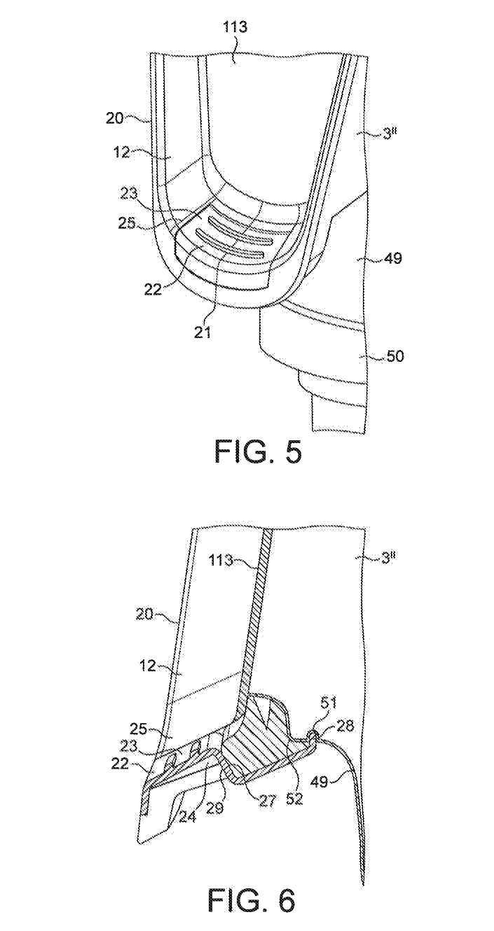

FIG. 5 shows an isometric view of a further alternative lever for a lever valve assembly comprising a lever fastening device; and

FIG. 6 shows a sectional side view of the lever valve assembly of FIG. 5.

FIG. 1 shows a valve assembly 3 comprising a lever 10, a valve body 8 and a valve body cover 5. The valve body 8 typically comprises brass or other metal, and the valve body cover 5 typically comprises a thermosetting plastic. In this example, a pressure gauge 100 is located in the valve body. A moulded opening 17 in the valve body cover 5 surrounds the pressure gauge 100 (see FIG. 2). As shown in FIG. 1, when the lever is in the closed position, the pressure gauge 100, and a portion of the surrounding valve body cover 5, project through an opening 16 in the base 13 of the lever 10.

The lever 10 comprises a base 13, two side walls 14 and a lower wall 15. A lip 11 extends downwardly from the outer edge of the lower wall 15. The lip 11 forms a convenient finger hold position for a user.

FIG. 2 shows the valve assembly 3 with the lever in the open position. As shown, the valve body cover 5 may include a visual indication such as the word “open” or may be of, or include, a different colour, to indicate that the valve is open.

In the embodiment shown in FIGS. 1 and 2, the side walls 14 and lower wall 15 form a continuous wall 12 surrounding the side and bottom periphery of the lever 10. It will be understood that in the context of this description the terms “bottom”, “lower”, “upper” etc. are with reference to the lever 10 when in the closed position in use as shown in FIG. 1.

When the lever 10 is in the closed position, the peripheral wall 12 provides protection for the gauge 100 as the peripheral wall 12 projects beyond the front face of the gauge 100 thereby protecting the gauge 100 from blunt impacts in the event that the cylinder, to which the valve assembly 3 is attached in use, falls over (for example during transit), or in the event that the lever 10 is struck by an object such as a spanner or the like. Of course, the peripheral wall 12 will not provide protection in all circumstances, and it is foreseeable that a small object, or the end of a thin object, will be able to pass within the bounds of the wall 12 and damage the gauge 100. Nonetheless, the peripheral wall 12 makes such damage less likely since, for an object to damage the gauge 100, it must strike the lever in a certain way.

It is not necessary that the gauge 100 protrude through the opening 16 in the base 13. In an alternative embodiment (not shown) the gauge 100 may be situated entirely behind the lever 10 when in the closed position. The gauge 100 may be recessed into the valve body 8 and/or the valve body cover 5.

A further alternative valve assembly 3′ is shown in FIGS. 3 and 4. The valve assembly 3′ comprises a valve body 8, a valve body cover 5 and a lever 30. The lever 30 is similar in most respects to the lever 10 of FIGS. 1 and 2. However, the base 230 of the lever 30 has no opening such that the pressure gauge 100 is located behind the lever 30 when the lever is in the closed position. This provides additional protection to the gauge as the face of the gauge is protected by the base 230 of the lever 30.

FIGS. 5 and 6 show a further alternative embodiment of a valve assembly 3″ comprising a lever 20, valve body 50 and valve body cover 49. The lever 20 is similar to the lever 10 described above in respect of FIGS. 1 and 2. However, in this embodiment there is no opening 16 in the base 113 and the lever 20 comprises an actuation device 22 located in the lower wall 25 of the lever 20. As above, the lever 20 comprises a lip 21 which projects downwardly from the lower wall 25 to provide a grip position for a user.

As described in greater detail below, the actuation device 22 is arranged to selectively prevent disengagement of the lever 20 from the valve body cover 49, depending on the operation of button 23 by a user.

As most clearly shown in FIG. 6, the base 113 of the lever 20 rests against the valve body cover 49 of the valve assembly 3″ when the lever 20 is in the closed position. The actuation device 22 comprises a button 23. The actuation device 22 extends through an opening 29 in the lever 20 and extends below the lever 20 to a hook portion 28. An indent 51 is provided in the valve body cover 49. In use, when the valve lever 20 is in the closed position, the hook portion 28 engages with the indent 51 and fastens the lever 20 in place. A spring (not shown) is located in a space 24 between the lower side of the button 23 and the upper side of the base 25 of the lever 20. The spring biases the button 23 upwardly away from the base 25 so that the hook 28 is maintained in engagement with the indent 51. If disengagement of the lever is desired, a user must depress the button 23 against the spring force to move the hook 28 out of engagement with the indent 51, thereby releasing the lever 20.

In each embodiment described above, the continuous wall 12 formed by the lower wall 15, 25 and the side walls 14 provides protection for any item located on or in the base 13, 230, 113. As described above, such an item may be a pressure gauge 100 which is received within an opening in the base of the lever. Alternatively, the rear wall may carry information, for example, regarding the contents of the cylinder to which the valve assembly is attached. In each case, the peripheral wall 12 provides protection for the item located in or on the base 13, 230, 113.

It will be apparent to the skilled reader that the lower wall 15 is not an essential feature of the invention and that the protection of an item located in or on the base 13 may be achieved by the side walls 14 alone. Similarly, the side walls 14 need not extend along the full length of the base 13 and it is sufficient for the side wall s14 to extend only part of the way along the length of the base 13.

The peripheral wall 12 may vary in depth along its length. In one example the lower portions of the side walls 14, proximate the lower wall 15 (if present), are deeper than the upper portions of the side walls 14 located at the upper end of the lever 10.

1. A lever for a lever operated valve, the lever comprising a base and at least two walls, wherein the at least two walls project away from the base such that, in use, when the lever is attached to a valve in the closed position, the at least two walls project outwardly away from the valve.

2. A lever for a lever operated valve as claimed in claim 1, wherein the at least two walls are located substantially opposite one another.

3. A lever for a lever operated valve as claimed in claim 1, wherein the at least two walls form part of a continuous peripheral wall.

4. A lever for a lever operated valve as claimed in claim 3, wherein the peripheral wall surrounds a major portion of the edge of the base.

5. A lever for a lever operated valve as claimed in claim 1, wherein the depth of at least one of the at least two walls varies along the length of the wall.

6. A lever for a lever operated valve as claimed in claim 1, wherein at least one of the at least two walls comprises a lip located substantially at its free edge,

7. A lever for a lever operated valve as claimed in claim 1, wherein the base comprises an opening.

8. A lever for a lever operated valve as claimed in claim 7, further comprising a protective member located within or over the opening,

9. A lever for a lever operated valve as claimed in claim 1, wherein at least one of the at least two walls comprises a button for the operation of an actuation device of a lever fastening device.

10. A lever operated valve assembly comprising a valve body and a lever, the lever comprising a base and at least two walls, wherein the at least two walls project away from the base such that, in use, when the lever is attached to a valve in the closed position, the at least two walls project outwardly away from the valve.

11. A kit of parts for forming a lever operated valve assembly, the kit comprising a valve body and a lever, the lever comprising a base and at least two walls, wherein the at least two walls project away from the base such that, in use, when the lever is attached to a valve in the closed position, the at least two walls project outwardly away from the valve.
